(19) United States
(12) Patent Application Publication
(10) Pub. No.: US 2012/0139464 A1
(43) Pub. Date: Jun. 7, 2012

(54) Synchronous reluctance motor, operating machine comprising the motor and method for controlling the motor

(75) Inventors: Davor Filipeti, Labin (HR); Boris Karuzic, Labin (HR); Ezio Bertotto, Bolzano Vicentino (IT)

(73) Assignee: REEL S.R.L., Ponte Nanto (VI) (IT)

(21) Appl. No.: 13/320,532

(22) PCT Filed: May 17, 2010
(86) PCT No.: PCT/IB2010/052182

§ 371 Date: Feb. 22, 2012

(30) Foreign Application Priority Data
May 15, 2009 (IT) PD2009A000140

(51) Int. Cl. H02P 6/18; H02K 19/02

(52) U.S. Cl. 318/400.34; 310/46

(57) ABSTRACT

A synchronous reluctance motor comprises a stator (2) having at least one pair of poles and a plurality (ns) of grooves (3) for each pair of poles, a transverse-laminated rotor (5) with a plurality of disk-line sheet metal members (7, 7′, 7″, . . . ) of predetermined outside diameter (D), each having a plurality of adjacent slots (8, 8′, . . . ; 9, 9′, . . . ; 10, 10′, . . . ; 11, 11′, . . . ) and a central through hole (12) of predetermined inside diameter (d), each slot (8, 8′, . . . ; 9, 9′, . . . ; 10, 10′, . . . ; 11, 11′, . . . ) having a substantially curved elongate shape, symmetrical with respect to a radius, with end portions closed at the edge (13) of a corresponding sheet element (7, 7′, 7″, . . . ) to define corresponding ribs (14, 14′, 14″), which are adapted to be magnetically saturated to be equivalent to rotor slots. At least one first portion of the sheet elements (7, 7′, 7″, . . . ) has a ratio of the inside diameter (d) to the outside diameter (D) equal to or greater than 0.45 and a number (nr) of equivalent rotor slots (14, 14′, 14″) equal to the number (ns) of stator grooves (3) per pole pair, decreased or increased by four units.

### FIELD OF THE INVENTION

The present invention generally finds application in the field of electric motors and particularly relates to a synchronous reluctance motor.

The invention further relates to an operating machine, particularly a compressor, comprising the motor of the invention, as well as a method for controlling such motor.

### BACKGROUND ART

Synchronous reluctance motors are known to have various applications in the field of operating machines because, in addition to relative cost-effectiveness and simple construction, they ensure easy electric control and provide a constant torque as a function of speed.

Nevertheless, these motors generally have poorer performances, in terms of deliverable power and attainable speeds, than other types of electric motors, such as induction motors or synchronous permanent magnet motors.

In order to at least partially obviate these limitations and achieve performances similar to those of better performing motors, reluctance motors are designed to exhibit enhanced magnetic anisotropy.

A particular type of synchronous reluctance motors, known as transverse-laminated motors, involves the use of a rotor consisting of a pack of ferromagnetic core plates, in which a plurality of radially offset elongated slots, open at their ends, are formed to obtain a proper magnetic flux.

Nevertheless these solutions suffer from marked magnetic field oscillations, that may result in a corresponding torque ripple of the rotor shaft.

The above limitations restrict their industrial use in operating machines, such as pumps, compressors, refrigerating units.

For instance, in refrigerating units, particularly of the type comprising a compressor for compressing a refrigerant fluid, a condensing battery for subtracting latent heat from the compressed fluid, an evaporating battery with a thermostatic valve for fluid expansion, the compressor is generally equipped with an asynchronous motor, because such type of motor is deemed to involve low energy consumption.

Nevertheless, the use of asynchronous motors involves certain drawbacks, one of which is the occurrence of considerable rotor friction losses. Furthermore, rotation speed control is not easy.

Typically, during operation, a compressor does not constantly operate in steady-state conditions because, when the temperature setpoint is reached in the environment to be cooled, the compressor power is reduced. For this purpose, multiple compressors may be used, to be individually enabled or disabled as required, which apparently involves an increase of costs and sizes.

Other solutions, such as the use of synchronous permanent magnet motors, are not always feasible because, in spite of their negligible rotor losses, these motors are particularly expensive, due to the permanent magnets used therein. Furthermore, magnets are subjected to degradation in case of long contact with the refrigerant liquid.

Also, the flow of refrigerant fluid through the motor causes a further efficiency loss in the refrigerating unit. The through holes that are formed in the rotor cannot affect the mass of the rotor, and hence are not large enough as to ensure a consistent flow of fluid. In other words, they act as a “bottleneck” in fluid circulation. Therefore, considerable losses occur in the fluid circuit, that require compensation through a more intensive work by the compressor, and hence the motor.

Due to the above reasons, the prior art operating machines, such as compressors for refrigerating units, that use synchronous reluctance motors do not afford satisfactory performances.

In an attempt to at least partially obviate these drawbacks synchronous reluctance motors have been provided, in which the rotor core laminations have elongate slots closed at their ends. Thus, electromagnetic field saturation ribs are formed at said ends, in the peripheral portion of the laminations, whose magnetic behavior is similar to that of air.

In practice, the magnetic flux at these ribs is negligible or anyway considerably lower than the magnetic flux at the ferromagnetic material, so that equivalent rotor slots may be defined.

The best oscillation reduction performance was experimentally found to be obtained when the number of these equivalent rotor slots is equal to the number of stator grooves per pole pair, increased or decreased by four.

However, these additional rotor configurations have shown certain limitations, in particular operating machine applications.

Indeed, for the rotor to be secured to the drive shaft, the rotor laminations have a central hole having the same diameter as the shaft.

This configuration involves a considerable increase of the axial dimension of the motor, and hence restricts its application potential.

EP-A1-1 793 469 discloses a compressor having an improved synchronous reluctance motor that at least partially solves these dimensional problems.

This motor has a rotor comprising two distinct portions of laminations, i.e. a first portion having an enlarged central hole for partial insertion of the shaft hub, to reduce the axial dimension, and a second portion with a diameter that matches the shaft diameter.

Nevertheless, in this prior art solution, the enlargement of the hole involves a change in slot configuration, i.e. a reduction in their number per pole, or a deformation, i.e. a reduction of their axial extension at the diametrical portion, which involves an efficiency loss.

### DISCLOSURE OF THE INVENTION

The object of the present invention is to overcome the above drawbacks, by providing a synchronous reluctance motor having increased performances as compared with prior art motors.

A particular object is to provide a synchronous reluctance motor that can be coupled to the hub of a drive shaft of an operating machine or also to relatively large diameter shafts of operating machines, thereby always ensuring high efficiency and affording a reduction of the axial dimension.

A particular object is to provide an operating machine, particularly a compressor, that has a relatively small axial dimension.

Another object is to provide an operating machine, particularly a compressor, that has higher performances than prior art compressors.

Yet another object is to provide an operating machine, particularly a compressor, that minimizes rotor friction losses and allows simple, accurate and precise control of the rotation speed, by power capacity control.

Another important object of the invention is to provide a method for controlling a synchronous reluctance motor that allows more resistant and particularly stable control.

These and other objects, as better explained hereafter, are fulfilled by a synchronous reluctance motor as defined in claim 1, which comprises a stator having at least one pair of poles and a plurality of grooves for each of said pairs of poles, a transverse laminated rotor defining a central axis of rotation which comprises a plurality of disk-line sheet metal members coaxial with said axis and having a predetermined outside diameter, each of said sheet elements having a corresponding plurality of slots and a central through hole of predetermined inside diameter for receiving the drive shaft of the machine.

For each of said sheet elements, said slots have an elongate curved shape, with end portions close to the edge of said sheet element, to delimit corresponding ribs, that are designed to be magnetically saturated and define corresponding equivalent rotor slots.

According to a peculiar feature of the invention, at least one first portion of the sheet elements has a ratio of the inside diameter to the outside diameter equal to or greater than 0.45 and a number of equivalent rotor slots equal to the number of stator grooves per pole pair, decreased or increased by four units.

With this peculiar feature, a rotor may be formed that has a central passageway of sufficient radial size as to accommodate larger drive shafts or the support hub of a drive shaft, which will afford a reduction of axial dimensions, while maintaining unchanged magnetic flux characteristics and ensuring the same motor performance as in the case of rotors with a smaller central passage.

The rotor so formed will also have a lighter weight and improved cost-effectiveness, as it will apparently require a smaller amount of material and also afford improved motor efficiency.

In another aspect, the invention relates to an operating machine as defined in claim 8, which comprises a work unit with a drive shaft rotating about a central axis and having a tubular support hub axially extending along at least part of said shaft, and a synchronous electric motor according to the present invention.

Advantageously, the hub has an outside diameter substantially equal to the inside diameter of the first portion of sheet elements of the rotor, to at least partially fit in said central passageway and thus reduce the axial dimension of the work unit.

The use of a synchronous reluctance motor will also afford easy and precise speed control, and reduce rotor losses to negligible values.

Furthermore, the laminated rotor with through apertures has a particularly light weight, and hence improves the overall motor performance. Such improvement compensates for performance losses, as compared with asynchronous motors, caused by the presence of the inverter. The technical assumption that synchronous motors have a poorer performance than asynchronous motors, well established in the art, is thus overcome.

Also, synchronous reluctance motors have the same stator as asynchronous motors. As a result, a motor for an operating machine, such as a compressor of a refrigerating unit, can be obtained from the motor of a prior art compressor by simply replacing the original rotor with a rotor according to the invention.

In yet another aspect, the invention relates to a method for controlling a synchronous reluctance motor, preferably but not necessarily of the type of the present invention, in which the method is as defined in claim 13.

This will afford a more resistant control, free from any wear. Furthermore, drift errors are similar to normal offsets, that can be compensated for by controllers, and if the angle of orientation is estimated with sufficient accuracy, the system is self-controlled and particularly stable.

Advantageous embodiments of the invention are defined in accordance with the dependent claims.

### BRIEF DESCRIPTION OF THE DRAWINGS

Further features and advantages of the invention will be more apparent from the detailed description of a few preferred, non-exclusive embodiments of a synchronous reluctance motor of the invention and an operating machine comprising the motor, which are described as non-limiting examples with the help of the annexed drawings, in which:

FIG. 1 is a sectional view of a motor of the invention in a first preferred configuration;

FIG. 2 is a perspective view of a rotor that is part of a motor of the invention;

FIGS. 3 to 6 are cross sectional views of a rotor that is part of the motor of the invention, in corresponding preferred configurations;

FIG. 7 is an axially sectional view of the rotor of FIG. 6;

FIG. 8 is an axially sectional view of an operating machine of the invention.

### DETAILED DESCRIPTION OF A PREFERRED EMBODIMENT

Referring to the above figures, a synchronous reluctance motor, generally designated with numeral 1, is designed to be mounted to the drive shaft S of an operating machine M, for example and without limitation a compressor, a pump or any turbomachinery.

Nevertheless, the motor 1 of the invention may find application in any field in which a motor of this type may be used.

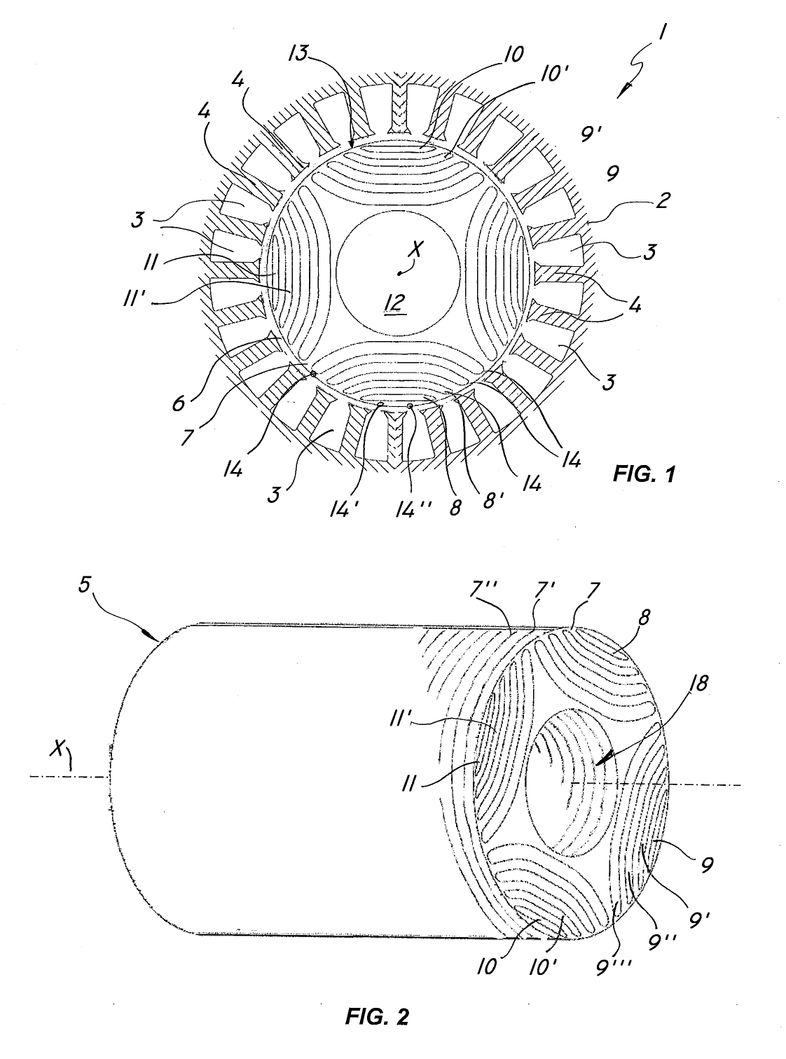

According to the invention, as shown in the sectional view of FIG. 1, the motor 1 comprises a stator 2 of known type, which has at least one pair of poles and a plurality nₛ of grooves 3 for each of said pairs of poles. Accordingly, the stator 2 will have a corresponding number of pole pieces 4.

In the illustrated configuration, the stator 2 has two pairs of poles and twenty-four grooves 3, hence the number nₛ of grooves 3 per pole pair will be 12.

However, it shall be understood that a greater number of pole pairs may be also provided, with no theoretical limitation, which will be selected according to the type of application and/or the overall size of the motor 1.

The latter also comprises a transverse laminated rotor 5 of substantially cylindrical shape, with a central axis of rotation X. The rotor 5 is accommodated in the stator 2 in a known manner, thereby defining a gap 6 therewith having an annular cross section.

Particularly, the rotor 5 is composed of a plurality of disk-line sheet metal members 7, 7′, 7″, . . . , coaxial with the central axis X and having a predetermined outside diameter D, not necessarily the same for all sheet elements 7, 7′, 7″, . . . .

Unless otherwise stated, reference will be made herein for simplicity to a single sheet element designated by the non-indexed numeral 7. Nevertheless, it shall be understood that all the parts related to the sheet element 7 may also relate, unless otherwise stated, to the other sheet elements 7′, 7″, . . . .

Each of the sheet elements 7 has a plurality of slots 8, 8′, 8″, . . . ; 9, 9′, 9″, . . . , 10, 10′, 10″, . . . , 11, 11′, 11″, . . . , and a central through hole 12 of predetermined inside diameter d for receiving the drive shaft S of the machine M.

The slots will also be designated for simplicity, unless otherwise stated, by non-indexed numerals, but it shall be understood that all the parts related to them may also relate, unless otherwise stated, to the other slots.

The slots 8, 9, 10, 11 have an elongate curved shape, symmetrical to a radius, with end portions close to the edge 13 of the corresponding sheet element 7, to delimit corresponding ribs 14, that are designed to be magnetically saturated and define corresponding equivalent rotor slots.

According to a peculiar feature of the invention, at least a first portion of the sheet elements 7 has a ratio of the inside diameter 6 to the corresponding outside diameter D of 0.45 or more.

Furthermore, the number nᵣ of equivalent rotor slots 14 is equal to the number nₛ of stator grooves 3 per pole pair, increased or reduced by four units, according to the relation nᵣ=nₛ±4.

Preferably, the number nᵣ of equivalent rotor slots 14 is greater than 6.

Furthermore, the number nₛ of stator grooves 3 per pole pair may be other than an integer multiple of the number nᵣ of equivalent rotor slots 14 per pole pair.

This embodiment will afford a considerable reduction or even an elimination of rotor losses and undesired magnetic flux oscillations during control of the speed of the motor 1 so formed.

Furthermore, a synchronous reluctance motor so obtained will have such physical characteristics as to ensure better performances, higher than currently used prior art asynchronous motors.

In a preferred configuration, the ratio between the diameters d/D ranges from 0.45 to 0.75 and preferably from 0.47 to 0.68, so that the rotor 5 may be used with the most common operating machines.

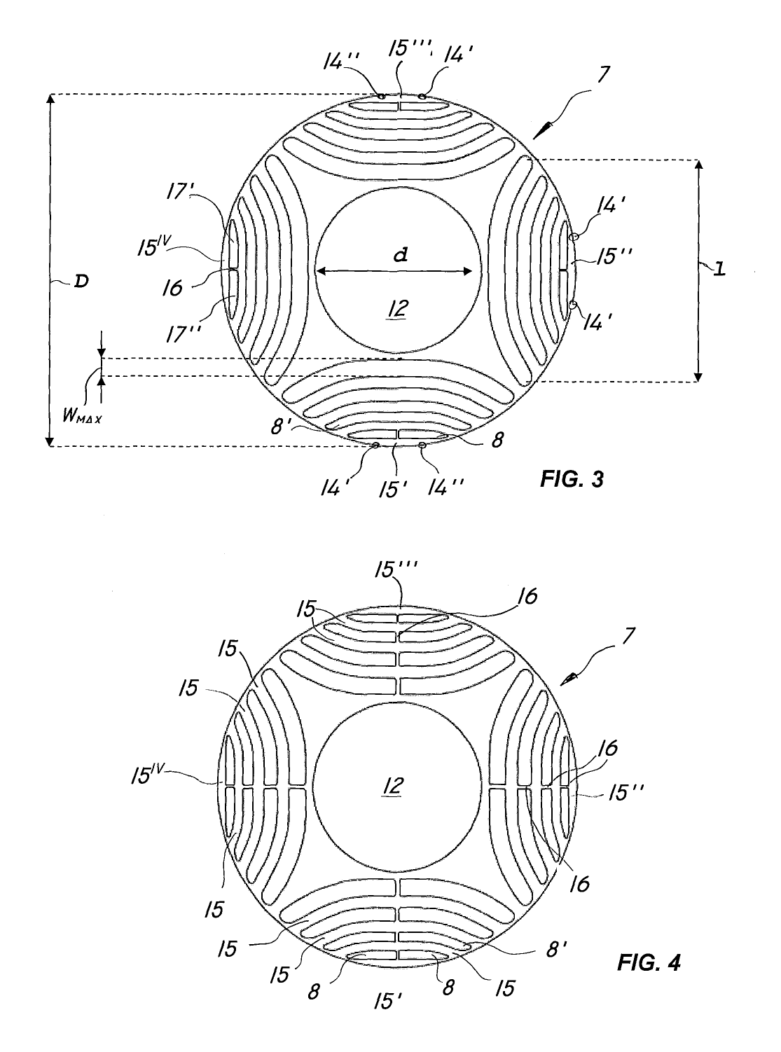

FIGS. 1, 3 and 4 show certain particular configurations of a sheet element 7 of the inventive rotor 5. Particularly, the sheet elements 7 of the figures have a diameter d/D ratio close to the minimum value of the above range.

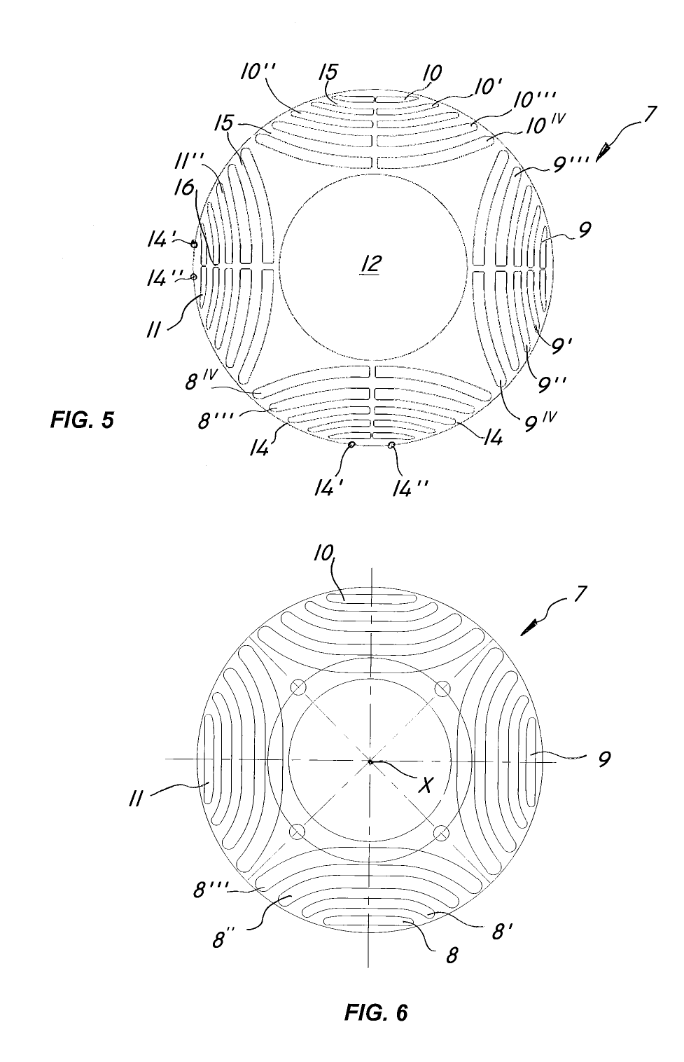

However, in FIG. 5, the sheet element 7 has a greater diameter d/D ratio, but a greater number of slots 8, 9, 10, 11 as compared with the other configurations.

In any case, the assumption that as the inside diameter d is increased, the slots have to be decreased or deformed is refuted.

In a first embodiment, all the sheet elements 7 may be identical and have the same ratio between their inside d and outside D diameters.

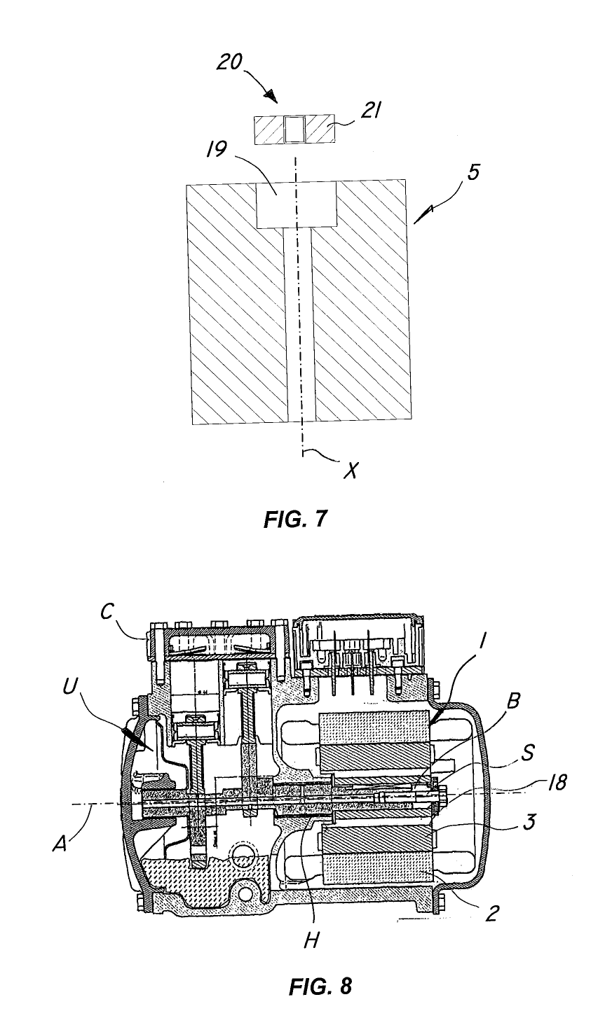

In a possible variant, as schematically shown in FIGS. 6 and 7, a second portion of sheet elements 7 may have a lower diameter d/D ratio than the above.

Of course, due to construction requirements, the sheet elements 7 will all have the same outside diameter D, regardless of the particular values of the inside diameter d.

The sheet elements 7 of the first portion and those of the second portion may be provided in any ratio. As an example, the first portion may account for 20% of the total number of sheet elements 7 of the rotor 5.

In any case, each of the sheet elements 7 will have identical series of slots 8, 9, 10, 11 at each of the poles of the stator 2, with no magnetic flux occurring thereat.

In the configurations of the figures, four series of slots 8, 9, 10, 11 are shown, because the stator 2 has four poles, but it shall be understood that there may also be two or more than four poles.

For each of these series 8, 9, 10, 11, the slots are radially offset and separated by magnetic segments, generally designated by numeral 15.

Advantageously, there may be four slots for each of the series 8, 9, 10, 11, like in FIGS. 1 to 4, or even more, e.g. five slots like in FIG. 5, advantageously allowing the use of a stator 2 with a greater number nₛ of grooves 3 per pole pair, with no particular limitation.

Each of the slots 8, 9, 10, 11 extends along a predetermined length between a pair of ribs 14 defining respective equivalent rotor slots.

Furthermore, the slots 8, 9, 10, 11 may either extend continuously between the corresponding ribs 14 or be interrupted by a substantially radial discontinuity 16.

These discontinuities 16 only act as structural reinforcements but are thin enough as to define high reluctance areas therein, with a reluctance similar to typical air reluctance, so that substantially no flux or a negligible flux occurs thereat.

Therefore, two half-slots 17, 17′ separated by a radial discontinuity 16 shall be intended herein as a single slot whose magnetic function is equivalent to a slot that seamlessly extends between corresponding end ribs 14.

Two end ribs 14 are defined at each slot 8, 9, 10, 11, each corresponding to an equivalent rotor slot.

Furthermore, at each of the outermost slots 8, 9, 10, 11 further peripheral segments 15′, 15″, 15′″, 15^{iv} are found, each defining respective pairs of equivalent slots 14′, 14″, located in the proximity of the center of the end slot 8, 9, 10, 11, at diametrically symmetrical positions, indicated by a circle in the figures, in which there is substantially no flux.

In practice, these peripheral segments 15′, 15″, 15′″, 15^{iv} might be divided into a pair of very thin segments separated by a very small discontinuity section. Nevertheless, for practical reasons, since the sheet element 7 is not easy to cut at such segments 15′, 15″, 15′″, 15^{iv}, it is preferable not to cut them further.

As shown in the figures, the slots of each series 8, 9, 10, 11 have radially increasing lengths l from the outer edge inwards of the corresponding sheet element 7.

Furthermore, each slot 8, 9, 10, 11 has a longitudinally variable radial width w with a maximum value wₘₐₓ preferably at a diametrical section.

Advantageously, the radial dimensions for the slots 8, 9, 10, 11 of each series have radially increasing maximum values wₘₐₓ from the outer edge inwards of the corresponding sheet element 7.

Preferably, the ratio of the length to the maximum radial dimension wₘₐₓ of each slot 8, 9, 10, 11 is preset and substantially constant throughout the slots 8, 9, 10, 11, which prevents the generation of harmonics susceptible of interacting with the harmonics generated by the stator 2.

FIG. 8 shows a particular application of a synchronous reluctance motor 1 of the invention, in which the motor 1 is coupled to the drive shaft S of a compressor C.

For instance, the compressor C may be inserted in a refrigerating unit, not shown, having at least one condensing battery, in which latent heat is subtracted from the refrigerant fluid, and at least one evaporating battery, in which the fluid is expanded to absorb external heat.

The motor 1 may be generally used with any operating machine M having a work unit U with a drive shaft S rotating about a central axis A and a tubular support hub H axially extending along at least part of the shaft S.

The work unit U is configured according to any typical pattern for the particular operating machine M and will not be described in further detail herein. For instance, in the case of a compressor C, it can be of the piston type, for compressing a refrigerant fluid.

The reluctance motor 1 is mounted coaxially with the drive shaft S, the latter being fitted into the central passageway 18 of the rotor 5. Particularly, at least part of the axial extension of the central passageway 18 of the rotor has an inside diameter φ′ greater than the diameter φ″ of the shaft S and substantially coincident with the outside diameter φ′″ of the hub H.

Therefore, the latter may be at least partially fit into the central passageway 18, thereby reducing the axial dimension of the work unit U.

In a preferred configuration, the central passageway 18 has a constant inside diameter φ′.

In this case, the drive shaft S may be suitably sized for the rotor 5 to be press fitted thereon, or an adapter bush B may be provided, extending along the whole or part of the axial extension of the passageway 18, depending on whether the hub H is entirely out of the passageway 18 or partially inserted therein.

This particular configuration of the rotor 5 will also simplify maintenance of the motor 1.

The central passageway 18, and particularly the section having the greater diameter φ′, defines a recess 19 susceptible of receiving locking means 20 for securing the rotor 5 to the shaft S.

These locking means 20 may include, for example, a nut 21 engaging on a threaded portion of the shaft S. The recess 19 allows the nut 21 to be wholly contained in the space occupied by the rotor 5 upon locking thereof.

Nevertheless, the above configuration of the sheet elements 7 of the first portion, where the recess 19 is defined, will still afford optimized magnetic flux distribution, unlike prior art solutions, which require their shape to be changed, and thus affect the efficiency of the whole rotor and increase the ripple.

The use of a rotor 5 with any one of the above configurations will also allow the number of slots 8, 9, 10, 11 to provide a particularly large total open surface, thereby affording a considerably improved flow of the working fluid, particularly in refrigerant fluid applications.

In the case of a compressor C, the motor 1 is more effectively cooled and the fluid circuit through the motor 1 will have lower losses than in prior art solutions, thereby requiring a less intensive work by the compressor C and hence by the motor 1, for compensating for such losses.

Therefore, no bottleneck will be created for the refrigerant fluid through the rotor 5, and this will increase the efficiency and performance of the whole machine M and hence of the refrigerating unit in which it is located.

According to a particular preferred, non limiting configuration of the invention, not shown, the machine M may include a device for controlling the position and rotation speed of the rotor 5 to allow control thereof without position and speed sensors.

Also, the control device may include means for measuring the voltage and current strength supplied to the motor 1, and at least one inverter susceptible of providing the supply voltage to the motor.

The inverter allows the rotation speed to be electronically controlled by controlling the supply current vector.

The inverter, that is part of the power circuit of the motor 1 may include switches, such as IGBT switches, for controlling the supply voltage and obtain a proper duty cycle.

Preferably, the switches are controlled at a switching frequency of 2 KHz to 8 KHz, and preferably of 4 KHz.

Although the use of an inverter tends to worsen the performance of the refrigerating unit as compared with units that require no inverter, the synchronous motor 1 still affords a better speed control than an asynchronous motor. Since the refrigerating unit can operate for a long time at speeds below the maximum speed, it will be understood that a better speed control may at least partially compensate for such performance loss.

In another aspect of the invention, the inverter may be also cooled by the refrigerant fluid.

Thus, as soon as the desired temperature is attained in the environment in which the refrigerating unit operates, the compressor C will be allowed to operate at lower rates, which will require the speed of the motor 1 to be decreased.

Particularly, this control device will be integrated in the synchronous motor 1 itself.

This will afford a more resistant control, free from any wear. Furthermore, drift errors are similar to normal offsets, that can be compensated for by controllers, and if the angle of orientation is estimated with sufficient accuracy, the system is self-controlled and particularly stable.

However, many types of control devices with no position and speed sensors are known.

According to a preferred aspect of the invention, the device may be designed to implement a method for controlling the motor 1, which comprises a first step in which the voltage and current supplied to the motor are directly or indirectly measured.

Particularly, the DC voltage supplied by the inverter to the motor 1 and the three-phase supply currents are directly measured by instruments such as voltmeters and ammeters.

Then, the Clarke transform will be used to convert the three-phase system quantity into a two-phase system integral with the stator 2, which is stationary and more conveniently treated. This transformation has the recognized advantage of preserving phase quantities and is thus suggested for practical implementations. In the case of voltages, the Clarke transform uses the duty cycle of the inverter in addition to the measured DC voltage.

Then, the supply current expressed in the stationary reference frame is calculated again according to a moving reference frame, integral with the rotor 5.

The current components of this additional reference frame are generally calculated by means of the equally known Park transform. This transform uses a feedback value of the position angle of the rotor 5 with respect to the stator 2, to be determined in a later step.

A second step consists in estimating the magnetic flux of the motor 2, using a model of its magnetic behavior, from the supply currents known according to the moving reference frame.

More in detail, the magnetic model may be of various types, either a linear or nonlinear model, and will be preferably expressed by nonlinear functions of current components in the moving reference frame and the rotation angle of the rotor 5. Once again, the calculation is performed by using a feedback value of the angle of rotation, which is determined in the above mentioned later step.

Particularly, such calculation is performed in a suitable flux estimator, by using a look up table, in which each pair of current values associates a pair of flux values in the moving coordinate system.

Then, the estimated flux in the moving reference frame may be expressed by the components in the stationary reference frame, using an inverse Park transform.

In a third step, an ideal magnetic flux is determined, which is obtained by integrating in time the supply voltage of the stationary reference frame decreased by the resistive losses in the stator 2.

A fourth step provides the combination of the ideal magnetic flux and the estimated magnetic flux to obtain an observed magnetic flux. The third step and the fourth step are preferably, but not necessarily carried out together by a single flux observer.

In a later fifth step, a first error signal is determined from an estimation of the angular position of the rotor 5 and from an angular position feedback value to be determined in a later step.

The estimated angular position value may be obtained by using appropriate trigonometric relations from the observed flux in the stationary reference frame and from the estimated flux in the moving reference frame of the rotor.

Particularly, assuming a modulus λ of the magnetic flux, its components in the stationary reference frame may be expressed as follows:

λ′=λ cos(θ+δ)

λ″=λ sin(θ+δ)

where θ is the position angle of the rotor 5 relative to the stator 2 in the stationary reference frame, whereas δ is the position angle of the rotor 5 relative to the stator 2 in the moving reference frame.

Likewise, the components in the moving reference frame are:

λ′″=λ cos(δ)eλ″″=λ sin(δ).

Therefore:

cos(θ)=cos((θ+δ)−δ)=cos(θ+δ)cos(δ)+sin(θ+δ)sin(δ),

sin(θ)=sin((θ+δ)−δ)=sin(θ+δ)cos(δ)−cos(θ+δ)sin(δ).

By using in these expressions the calculated flux values and the vector notation with the estimated flux in the moving reference frame λ_{moving}′=[λ′″ λ″″] and the observed flux in the stationary reference frame λ_{stationary}′=[λ′ λ″], the following expressions are obtained:

cos(θ′)=(λ_{moving}′×λ_{stationary}′)/λ2

sin(θ′)=(λ_{moving}′̂λ_{stationary}′)/λ2.

where θ′ is an estimate of the angular position of the rotor relative to the stator.

Once the cos(θ′) and sin(θ′) values have been estimated, the first error signal is determined by suitably filtering, by a low-pass filter, the difference Δθ between the value θ obtained from a feedback branch and the estimated value θ′. Furthermore, the difference Δθ may be calculated by the following trigomonetric expression:

Δθ=θ−θ′≈sin(θ−θ′)=sin(θ)cos(θ′)−cos(θ)sin(θ′).

The feedback value θ may be derived from a feedback branch which receives the angular position θ of the rotor, as determined in a later feedback step.

In the same manner as described above, the observed flux λ_{stationary}′ may be also converted from the fixed reference frame to the moving reference frame using the Park transform.

In a sixth step a frequency flux component is introduced and a second error signal is calculated by determining the difference Δλ between the observed flux and the estimated flux in the moving reference frame and by demodulating the frequency component in the difference Δλ. More in detail, the frequency flux component may be introduced along a first coordinate axis of the moving reference frame integral with the rotor 5, whereas the difference between the observed flux and the estimated flux may be only determined between the respective components of these fluxes along a second coordinate axis of the moving reference frame. Particularly, the coordinate axes may be substantially in quadrature and the first axis may be disposed along the minimum reluctance direction of the rotor 5. Hence, the difference Δλ, along the second axis may be obtained, which is proportional to [sin 2(θ−θ′)]/2.

Advantageously, the frequency component introduced in the flux may have a frequency ranging from 300 Hz to 800 Hz, preferably 400 Hz. The use of a relatively low frequency, such as 400 Hz, allows to limit the inductance values in the power circuit of the motor 1 and, as a result, to reduce voltage drops.

This particular arrangement further provides a motor with a higher torque availability and a higher capability to address sudden changes of the mechanical load thereon, even at intermediate rotation speeds of the rotor 5.

The calculation of the second error signal may sequentially involve filtering of the difference Δλ determined on the second coordinate axis by a high-pass filter, demodulation of the frequency component by using a heterodyne demodulator 6, and further filtering by a low-pass filter.

In a seventh step the first and second error signals are combined in a suitable electronic mixing circuit, to obtain a single error signal.

For example, the two error signals may be combined together by multiplying each error by a corresponding multiplication coefficient. The latter may be composed of a constant coefficient and a variable coefficient varying according to the rotation speed of the rotor 5.

The variable coefficients may increase the first error signal with respect to the second error signal for relatively high rotation speeds and increase the second error signal with respect to the first error signal for relatively low speeds, near zero.

The rotation speed of the rotor 5, which is used to determine the variable coefficients, is determined from the observed flux in the stationary reference frame and from the estimated flux in the moving reference frame. More in detail, in the same manner as described above, the difference Δθ is determined, and later filtered to obtain the rotation speed of the rotor 5.

In the feedback step a single error signal is introduced into a controller having a pair of integrators. Thus the angular position of the rotor is obtained at the output of the controller, and is used as a feedback signal in all the previous steps when the angular position value θ is required.

The position feedback value θ provides a closed loop that may be repeatedly executed with a predetermined cycle frequency. Particularly, at each repeated cycle, the calculations in the procedure from the first step to the feedback step may be performed using the value θ obtained at the end of feedback step of the previous cycle.

The combination of the first and second error signals upstream from a double integration provides a regular behavior over the full range of rotation speeds of the rotor 5, thereby considerably increasing the efficiency and performance of the refrigerating unit, as the speed of the motor 1 may be decreased without any undesired noise and malfunctioning, unlike the prior art.

In another aspect of the invention, an eighth step of the control method is provided, which uses the angular position θ determined in the feedback step, in a manner known per se, to control the motor 1 without the assistance of position and speed sensors.

In other words, with this particular configuration, the motion of the rotor 5 may be controlled in an accurate and regular manner, over a wide range of rotation speeds even without using position and speed sensors.

This control method will further improve the motor 1 of the invention, by affording high positioning precision throughout the operation range and especially regular operation even in very difficult situations, such us the transition between high speed operation and low speed operation, which is critical to improve the performance of an operating machine, particularly a compressor, or the refrigerating unit in which it is located.

However, it will be appreciated that this novel control method may be used with any synchronous reluctance motor, not necessarily of the type according to the present invention.

A control device, not shown, for implementing the method, may comprise means for measuring the supply voltage and currents to the motor and processing means for calculating estimates of the magnetic flux and the ideal magnetic flux to relate them and determine an observed magnetic flux.

These processing means are susceptible of calculating the first error signal and introducing the frequency flux component to calculate the second error signal.

Suitably, the control device comprises a motor controller, preferably but not necessarily contained in the processing means. It will also be susceptible of receiving a single error signal from the processing means, which is obtained by combining the first and second error signals according to the rotation speed of the rotor.

Particularly, the controller comprises the above mentioned pair of integrators, which are susceptible of determining the angular position of the rotor also from the single error signal, so that motor control can ensure a regular behavior over the full range of rotation speeds of the rotor.

The above description clearly shows that the motor of invention fulfills the intended objects and particularly meets the requirement of ensuring higher performances and minimized oscillations, with lower or no friction losses, as compared with the prior art.

The motor, operating machine and control method of the invention are susceptible of a number of changes and variants, within the inventive concept disclosed in the annexed claims.

All the details thereof may be replaced by other technically equivalent parts, and the materials may vary depending on different needs, without departure from the scope of the invention.

While the motor, operating machine and control method have been described with particular reference to the accompanying figures, the numerals referred to in the disclosure and claims are only used for the sake of a better intelligibility of the invention and shall not be intended to limit the claimed scope in any manner.

The invention claimed is:

1. A synchronous reluctance motor for an operating machine (M) having a drive shaft (S), wherein the motor comprises:
a stator (2) having at least one pair of poles and a plurality (nₛ) of grooves (3) for each of said pairs of poles;
a transverse laminated rotor (5) defining a central axis of rotation (X) which has a plurality of disk-line sheet metal members (7, 7′, 7″, . . . ) coaxial with said axis (X) and having a predetermined outside diameter (D);
each of said sheet members (7, 7′, 7″, . . . ) having a plurality of adjacent slots (8′, 8″, . . . ; 9, 9′, . . . , 10, 10′, . . . , 11, 11′, . . . , and a central through hole (12) of predetermined inside diameter (d) which is designed to be coupled with the drive shaft (S) of the operating machine (M); and
each of said slots (8, 8′, . . . ; 9, 9′, . . . ; 10, 10′, . . . ; 11, 11′, . . . ) having a substantially elongate curved shape, symmetrical to a radius, with closed end portions in proximity of an edge (13) of a corresponding sheet element (7, 7′, 7″, . . . ), to define corresponding ribs (14, 14′, 14″), that are designed to be magnetically saturated to be equivalent to rotor slots,
wherein at least one first portion of said sheet elements (7, 7′, 7″, . . . ) has a ratio of said inside diameter (d) to said outside diameter (D) equal to or greater than 0.45 and a number (nᵣ) of said equivalent rotor slots (14, 14′, 14″) equal to the number (nₛ) of said stator grooves (3) per pole pair, decreased or increased by four units (nᵣ=nₛ±4).

2. The motor as claimed in claim 1, wherein said ratio between said diameters (d, D) ranges from 0.45 to 0.75.

3. The motor as claimed in claim 1, wherein each of said sheet elements (7, 7′, 7″, . . . ) has, for each of said poles, radially offset series of said slots (8, 8′, . . . ; 9, 9′, . . . ; 10, 10′, . . . ; 11, 11′, . . . ), the number of said slots (8, 8′, . . . ; 9, 9′, . . . ; 10, 10′, . . . ; 11, 11′, . . . ) for each of said series being equal to or greater than four.

4. The motor as claimed in claim 3, wherein each of said slots (8, 8′, . . . ; 9, 9′, . . . ; 10, 10′, . . . ; 11, 11′, . . . ) has a predetermined length (I) that progressively increases toward the axis (X) of said rotor (5).

5. The motor as claimed in claim 4, wherein each of said slots (8, 8′, . . . ; 9, 9′, . . . ; 10, 10′, . . . ; 11, 11′, . . . ) has a longitudinally variable width (w) with a predetermined maximum value (wₘₐₓ) at its axis of symmetry, with said maximum value (wₘₐₓ) progressively increasing in an inward direction on the corresponding sheet element (7, 7′, 7″, . . . ) and with a substantially constant ratio (ρ) of said length (l) to said maximum width (Wₘₐₓ).

6. The motor as claimed in claim 3, wherein at least one of said slots (8, 8′, . . . ; 9, 9′, . . . ; 10, 10′, . . . ; 11, 11′, . . . ) has a substantially continuous extension between its end ribs (14).

7. The motor as claimed in claim 3, wherein at least one of said slots (8, 8′, . . . ; 9, 9′, . . . ; 10, 10′, . . . ; 11, 11′, . . . ) has a substantially radially extending thin discontinuity (16) which is adapted to define a high reluctance area, having a reluctance similar to air reluctance.

8. An operating machine comprising:
a work unit (U) having a drive shaft (S) with a central axis (A);
a hub (H) associated with said work unit (U) and keyed to said shaft (S) along at least part of its axial extension; and
a motor (1) with a stator (2) and a rotor (5) in substantially coaxial relation, said rotor (5) being composed of a plurality of sheet elements (7, 7′, 7″, . . . ) each having a central hole (12) and defining a central passageway (18) for receiving said shaft (S),
wherein said motor (1) is a synchronous reluctance motor as claimed in claim 1, said hub (H) having at least one axial portion with an outside diameter (φ′″) substantially equal to the inside diameter (d) of a predetermined number of said sheet elements (7, 7′, 7″, . . . ) of said rotor (5) to at least partially fit into said central passageway (18) and reduce axial dimension of said work unit (U).

9. The operating machine as claimed in claim 8, further comprising a control device for controlling position and rotation speed of said rotor (5) to allow control thereof without position and speed sensors.

10. The operating machine as claimed in claim 9, wherein said control device comprises means for measuring voltage and current strength supplied to said motor (1).

11. The operating machine as claimed in claim 10, wherein said control device comprises at least one inverter susceptible of supplying said supplied voltage to said motor (1).

12. The operating machine as claimed in claim 11, wherein said inverter is equipped with switches for adjusting said supplied voltage to obtain an appropriate duty cycle, said switches being controlled at a switching frequency ranging from 2 KHz to 8 KHz.

13. A method for controlling a motor (1) as claimed in claim 1, the method comprising the steps of:
a) calculating an estimated magnetic flux in said motor by measuring a supply voltage producing a current strength;
b) calculating an ideal magnetic flux by integrating said supply voltage in time, after subtraction of resistive losses in said stator (2), to relate them and determine an observed magnetic flux;
c) calculating a first error signal from an angular position value of said rotor and a feedback value for said angular position; and
d) introducing a frequency flux component and calculating a second error signal by determining the difference between said observed flux and said estimated flux and by demodulating the frequency component induced in said observed and estimated fluxes.

14. The method as claimed in claim 13, further comprising a step in which said first and second error signals are mixed together to generate a single error signal as a function of rotation speed of said rotor (5).

15. The method as claimed in claim 14, further comprising a step in which said angular position of said rotor is determined by integrating said single error signal to generate said feedback value.
